(19) United States
(12) Patent Application Publication
(10) Pub. No.: US 2007/0230458 A1
(43) Pub. Date: Oct. 4, 2007

(54) Communication Network, Communication Apparatus, Communication Control Method and Communication Control Program

(75) Inventors: Teruyuki Baba, Tokyo (JP); Yoshihiko Suemura, Tokyo (JP); Nobuharu Kami, Tokyo (JP); Itaru Nishioka, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tpkyo (JP)

(21) Appl. No.: 11/571,096

(22) PCT Filed: Jun. 24, 2005
(86) PCT No.: PCT/JP05/11592

§ 371 Date: Dec. 21, 2006

(30) Foreign Application Priority Data
Aug. 23, 2004 (JP) 2004-241852

(51) Int. Cl. H04L 12/56

(52) U.S. Cl. 370/389

(57) ABSTRACT

[PROBLEMS] To enable automatic setting of corresponding relations between data links and bundled links thereof.

[MEANS FOR SOLVING PROBLEMS] A temporary bundled link forming device (13) associates data links having the same port attributes within own communication apparatus with the identical temporary bundle link ID. A data link neighbor discovery device (11) obtains the neighboring node IDs of the data links. A bundled link forming device (14) automatically sets, as a bundled link, the data links having the same neighboring node IDs obtained by the data link neighbor discovery device (11), among the data links that are associated with the same temporary bundled link ID by the temporary bundled link forming device (13).

### TECHNICAL FIELD

The present invention relates to a communication apparatus and a communication network, and to a control method and a control program thereof. More specifically, the present invention relates to a network automatic setting system and method for automatically setting relevance between a data link that transmits data and a bundled link to be advertised within a network.

### BACKGROUND ART

In the next-generation network, there are used apparatuses constituted with various technologies, e.g. routers for switching packets, optical cross-connectors for switching wave paths, etc. For uniformly controlling such network constituted with different technologies, standardization of GMPLS (Generalized Multiprotcol Label Switching) has been carried out in IETF (Internet Engineering Task Force).

A concept of TE link (a bundle of a plurality of links) is employed in the GMPLS. A plurality of data links are bundled to be treated as a single TE link, and it is used in order to reduce the advertisement amount in the routing protocol and to improve the scalability. In order to enable routing through the use of the TE link, IDs of neighboring nodes, metric for performing traffic engineering by routing calculation, and SRLG (Shared Risk Link Group) are allotted to the TE link. It is noted that the neighboring node means the neighboring communication apparatus among a plurality of communication apparatuses that constitute a communication network. Further, ID of the neighboring node means the identification information that is given to each communication apparatus for discriminating the plurality of communication apparatuses from each other.

SRLG is used for identifying the links that become unavailable simultaneously when there is generated a fault. For example, the TE links are bundles of a plurality of links, which are placed in a duct line buried under the ground. Thus, through allotting the same SRLG to the TE links lying in the same duct line, it becomes possible to know the range of influence when there is a fault generated within the duct line. With this, it becomes possible to prevent both the active path and the standby path from being affected simultaneously by a single fault, through selecting the paths that are not of the same SRLG for active and standby. The SRLG discriminates the influence of each fault point, so that it is necessary to allot unique values within the network.

In order to check, among the information regarding the TE link, the connecting relation of the data links that belong to the TE link, and to establish relevance between the TE link and the data link, Non-Patent Literature 1 proposes LMP (Link Management Protocol) in IETF.

In a conventional TE-link establishing method in LMP, a neighbor discovery start message is transmitted to a neighboring node at first. This neighbor discovery start message contains the ID of the TE link whose corresponding relation with respect to the data link needs to be established. Through the neighbor discovery start message, the TE link indicated in the message is established, and there is found the neighboring-node-side ports of the data links that belong to the TE link. It is noted that the data link means the transmission path for mutually exchanging data between communication apparatuses included in the communication network.

The neighboring node that has received the neighbor discovery start message returns a neighbor discovery start response message, indicating that preparation for discovering a neighbor is completed. Upon receiving the neighbor discovery start response message, the transmitter-side of the neighbor discovery start message refers to the corresponding relation that has been set in advance between the TE links and the data links, and transmits a test message to the data link that belongs to the TE link that is designated by the neighbor discovery start message. The test message contains the port ID of the transmitter side. Thus, by having the port ID received in the neighboring node returned with a test succeeded message, the neighboring relation of the data links can be recognized on both ends of the link, respectively. When the data link is cut or connected in a wrong manner, the test message cannot be received in the neighboring node. Thus, the test succeeded message is not returned, and the transmitter side of the neighbor discovery start message can discover that there is a fault in the connection of the data link. It is noted that the port ID means the identification information for identifying ports provided to the apparatus main body.

Through checking the connection of the data links in this manner based on the corresponding relation of the TE links and the data links set in advance, the corresponding relation between the TE link and the data link can be established. Then, through setting metric and SRLG for the established TE link, it is possible to set the paths by routing and signaling.

Non-Patent Literature 1: Link Management Protocol (LMP), IETF Internet Draft (draft-ietf-ccamp-10.txt), p16, Chapter 5, October 2003

### DISCLOSURE OF THE INVENTION

With the conventional LMP method, however, it is necessary to preset the corresponding relation between the TE links and the data links artificially. Thus, it is likely to have setting errors, and the number of setting steps is increased.

Further, with the conventional LMP method, it is not possible to perform automatic setting of parameters, e.g. metric and SRLG which allot the values based on the topology of the entire network. Therefore, there expands the network scale and increases the number of parameters that need to be set artificially, which tends to cause setting errors and to increase the number of setting steps.

An object of the present invention is to provide a communication network, etc., which automatically sets the corresponding relations between the TE links and the data links by utilizing a message that is defined in a conventional LMP method.

Furthermore, another object of the present invention is to provide a communication network, etc., which automatically sets the values of metric and SRLG as well, by considering the information on the entire network.

In order to achieve the aforementioned objects, the communication network according to the present invention is a communication network that is built by mutually connecting a plurality of communication apparatuses through transmission paths, wherein
the communication apparatuses mounted in the communication network comprise a temporary bundled link forming device, a data link neighbor discovery device, and a bundled link forming device, wherein:
the temporary bundled link forming device has a function of bundling transmission paths that have same attribute of ports provided to main bodies of the apparatuses, and giving identification information to the bundled transmission paths;
the data link neighbor discovery device has a function of obtaining the identification information given to a communication-target communication apparatus, and the identification information given to the bundled transmission paths of the communication-target communication apparatus; and
the bundled link forming device has a function of determining the transmission paths whose identification information match with each other as a bundled link, based on the identification information of the communication-target communication apparatus, the identification information of the bundled transmission paths of the communication-target communication apparatus, and the identification information of the transmission paths formed by the temporary bundled link forming device.

The communication apparatus used for the communication network according to the present invention is a communication apparatus for a communication system connected to each other through transmission paths, which comprises a temporary bundled link forming device, a data link neighbor discovery device, and a bundled link forming device, wherein:
the temporary bundled link forming device has a function of bundling transmission paths that have same attribute of ports provided to main bodies of the apparatuses, and giving identification information to the bundled transmission paths;
the data link neighbor discovery device has a function of obtaining the identification information given to a communication-target communication apparatus, and the identification information given to the bundled transmission paths of the communication-target communication apparatus; and
the bundled link forming device has a function of determining the transmission paths whose identification information match with each other as a bundled link, based on the identification information of the communication-target communication apparatus, the identification information of the bundled transmission paths of the communication-target communication apparatus, and the identification information of the transmission paths formed by the temporary bundled link forming device.

The communication control method according to the present invention is a communication control method for controlling a plurality of communication apparatus that are connected mutually on a communication network through transmission paths, the method comprising the steps of:
for each of the communication apparatuses, a step for bundling transmission paths that have same attribute of ports provided to main bodies of the apparatus, and giving identification information to the bundled transmission paths;
for each of the communication apparatuses, a step for obtaining the identification information given to a communication-target communication apparatus, and the identification information given to the bundled transmission paths of the communication-target communication apparatus; and
for each of the communication apparatuses, a step for determining the transmission paths whose identification information match with each other as a bundled link, based on the identification information of the communication-target communication apparatus, the identification information of the bundled transmission paths of the communication-target communication apparatus, and the identification information of the transmission paths formed by a temporary link forming device.

The communication control program according to the present invention is a communication control program for controlling a plurality of communication apparatuses that are connected mutually in a communication network through transmission paths, the program enabling a computer to execute:
for each of the communication apparatuses, a function of bundling transmission paths that have same attribute of ports provided to main bodies of the apparatus, and giving identification information to the bundled transmission paths;
for each of the communication apparatuses, a function of obtaining the identification information given to a communication-target communication apparatus, and the identification information given to the bundled transmission paths of the communication-target communication apparatus; and
for each of the communication apparatuses, a function of determining the transmission paths whose identification information match with each other as a bundled link, based on the identification information of the communication-target communication apparatus, the identification information of the bundled transmission paths of the communication-target communication apparatus, and the identification information of the transmission paths formed by a temporary link forming device.

In the present invention, the temporary bundled link forming device bundles the transmission paths whose attributes of the ports provided to the apparatus main body are the same, and gives the identification information to the bundled transmission paths. Then, the data link neighbor discovery device obtains the identification information given to the communication-target communication apparatus and the identification information given to the bundled transmission paths of the communication-target communication apparatus. The bundled link forming device establishes the transmission paths whose identification information matches each other, based on the identification information of the communication-target communication apparatus, the identification information of the bundled transmission paths of the communication-target communication apparatus, and the identification information of the transmission paths formed by the temporary bundled link forming device.

With this, the corresponding relations between the data links and the bundled links formed by the temporary link forming device can be utilized when discovering the neighbors of the transmission paths (data links). Thus, the conventional LMP neighbor discovery message can be used as it is. Furthermore, through grouping the data links that have the same properties by the temporary bundled link forming device and further grouping the data links whose identification information matches each other by the bundled link forming device, the data links having the same properties and the same neighboring node can be taken as a single bundled link and the corresponding relation thereof can be set automatically.

Further, in the present invention, the communication apparatus may be provided with a link information supply device for informing the information of the bundled link formed by the bundled link forming device to the outside. Furthermore, the communication apparatus may comprise: a link information forming device for allotting a new link attribute to the bundled link based on the bundled link information supplied from the link information supply device of the slave apparatus; and a link information collecting/distributing device for collecting the bundled link information from the link information supply device of the slave apparatus to output the information to the link information forming device, and distributing the link attribute allotted by the link information forming device to the slave apparatus.

With the above-described constitution, the link information collecting/distributing device within the communication apparatus as the master collects the bundled link information through the link information supply device within the communication apparatus as the slave. Then, the link information forming device within the communication apparatus as the master allots the new link attribute to the bundled link based on the collected bundled link information of the entire network. Thereafter, the link information collecting/distributing device within the communication apparatus as the master distributes, to the communication apparatuses, the link information that is formed anew by the link information forming device, and each of the communication apparatuses sets the distributed link information to the bundled link.

With this, the communication apparatus as the master can collect the link information of the entire network. Thus, it is possible to perform automatic setting of SRLG that requires unique values to be set within the entire network.

With the present invention as described above, in a network using a plurality of data links in a single bundled link for routing, the transmission paths having the same port attribute within the own communication apparatus are bundled, the identification information is given to the bundled transmission paths, and the transmission paths whose identification information matches each other are established as the bundled link, based on the identification information of the communication-target communication apparatus, the identification information of the bundled transmission paths of the communication-target communication apparatus, and the identification information of the transmission paths formed by the temporary bundled link forming device. Therefore, the number of errors and the steps for setting the corresponding relations between the data links and the bundled links can be reduced.

Furthermore, the communication apparatuses connected to each other can mutually utilize the identification information given to those communication apparatuses and the identification information of the bundled transmission paths of the communication apparatuses. Thus, it is possible to utilize the neighbor discovery message held at the conventional LMP communication apparatus that requires pre-setting of the corresponding relation. Therefore, it remains the compatibility with LMP-enabled communication apparatuses.

Moreover, since the link information forming device within the communication apparatus as the master allots the new link attribute to the bundled link based on the collected bundled link information of the entire network, SLRG that requires unique values to be set in the entire network can be set automatically. Therefore, the number of errors and steps at the time of setting can be reduced.

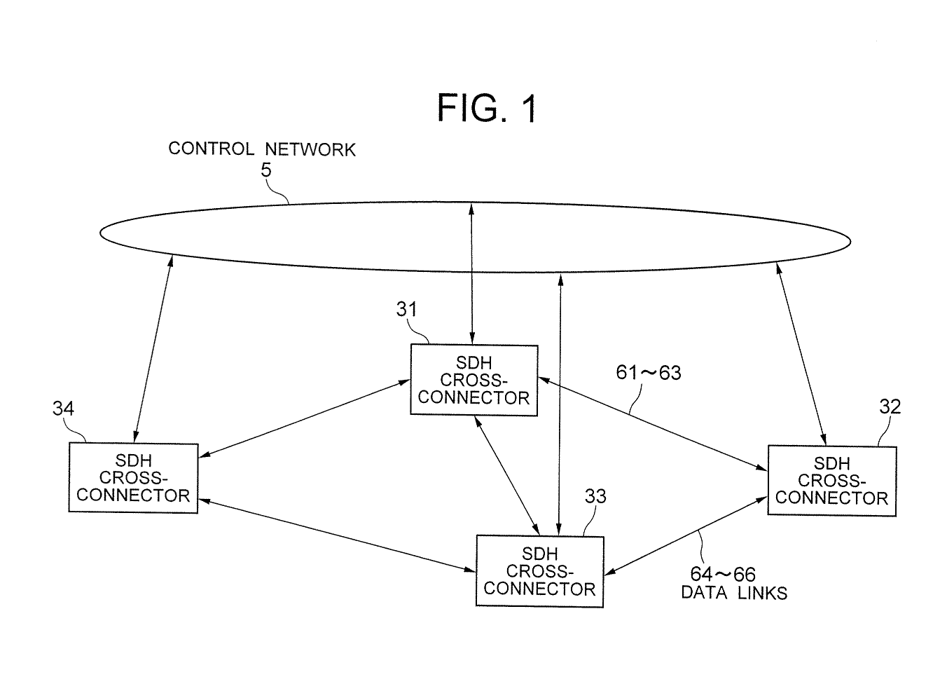

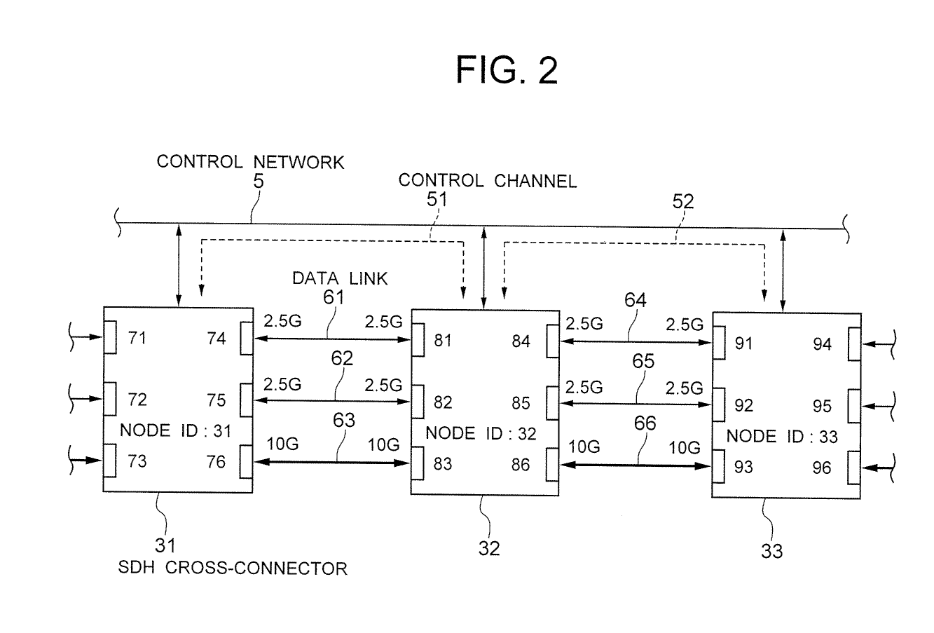

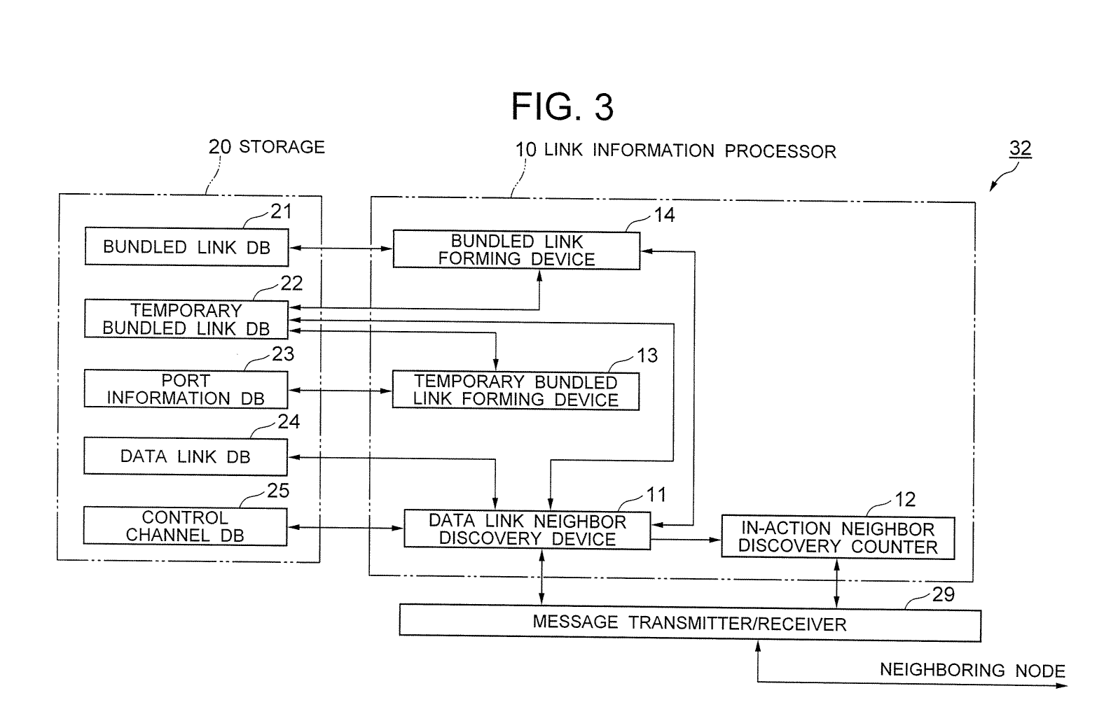

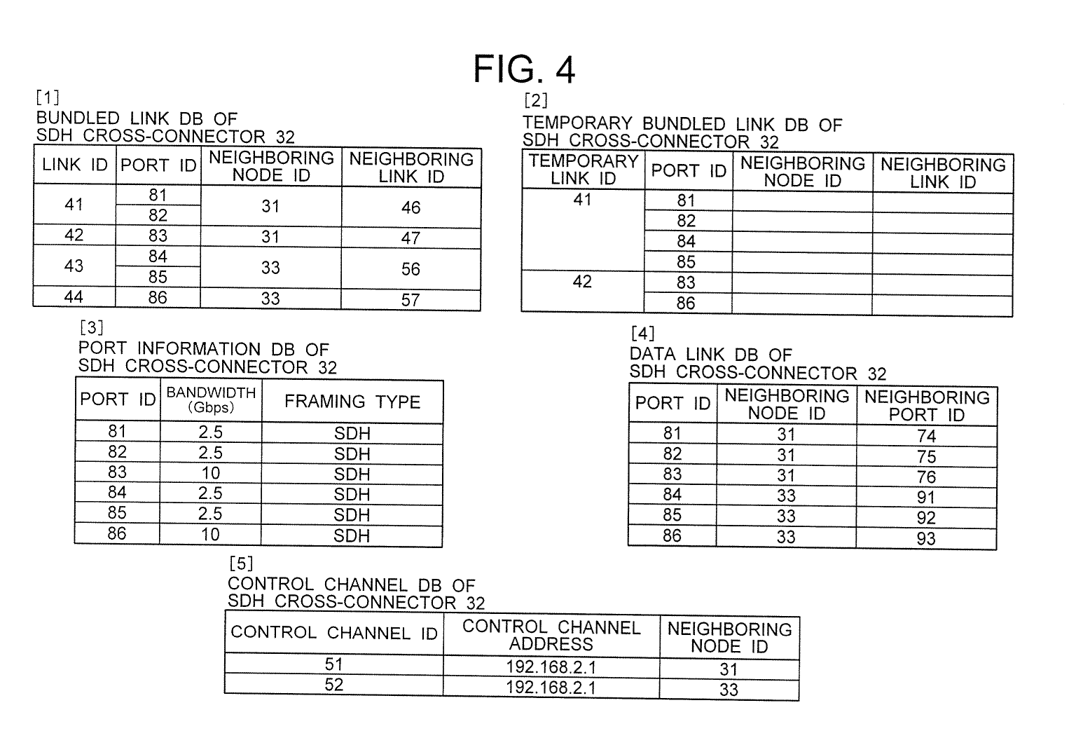

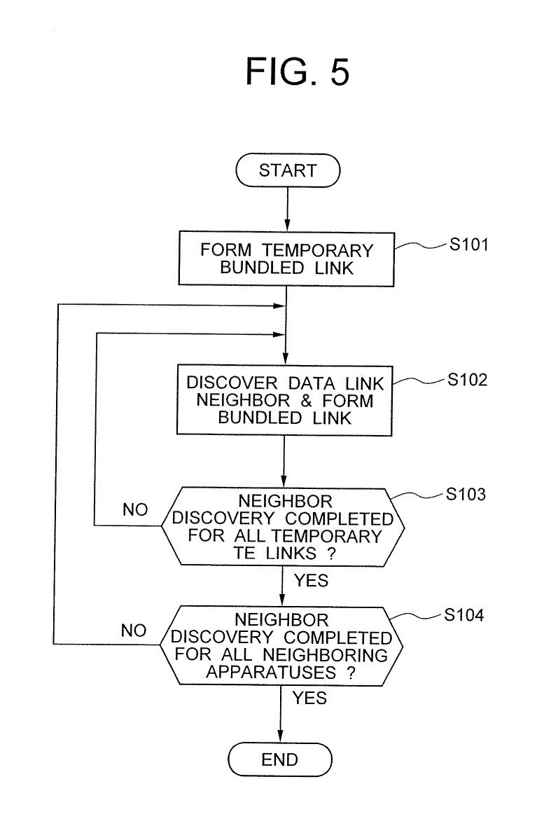

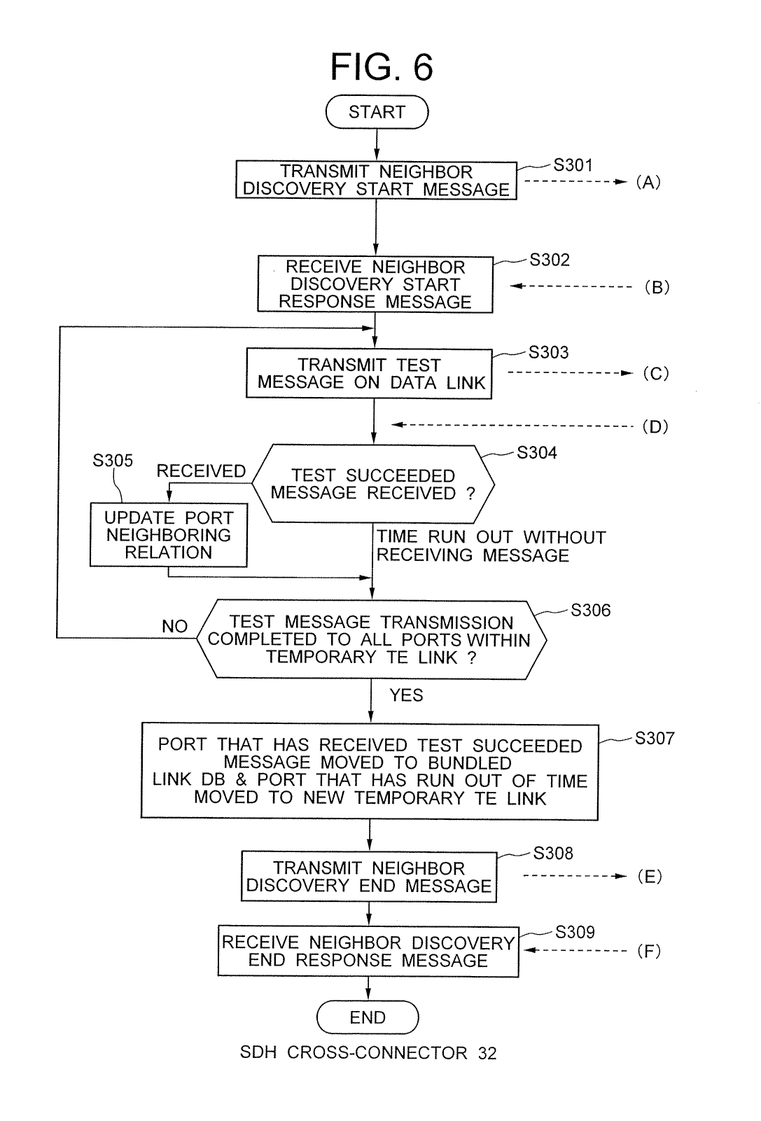

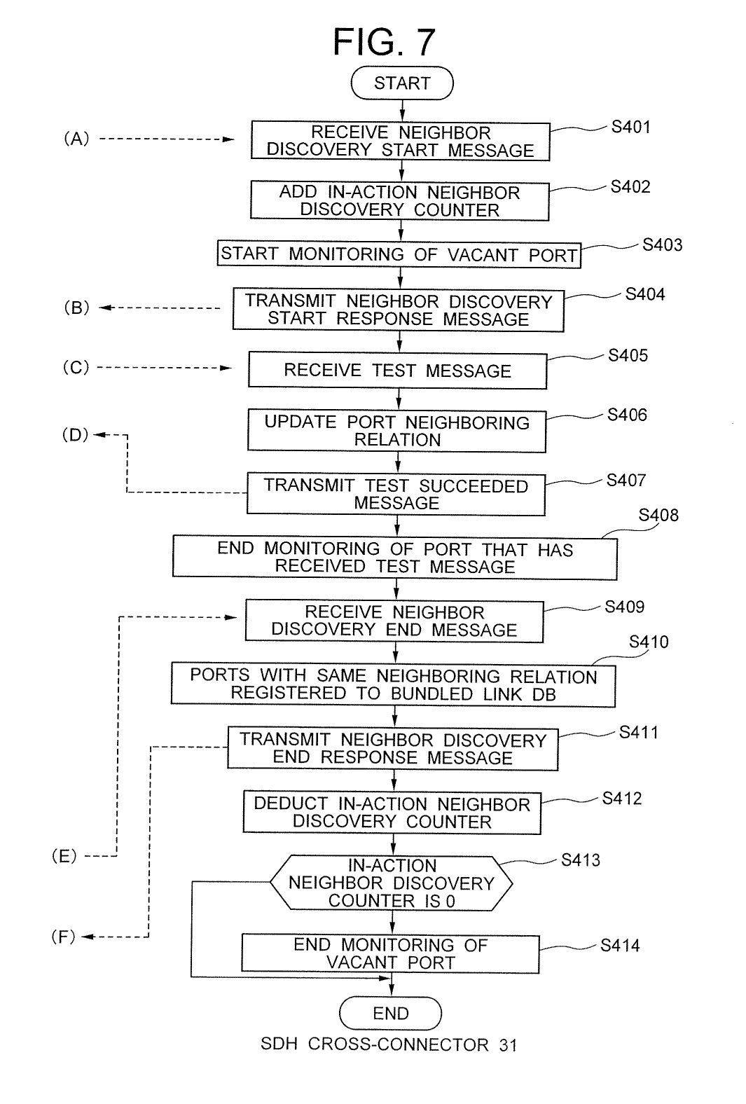

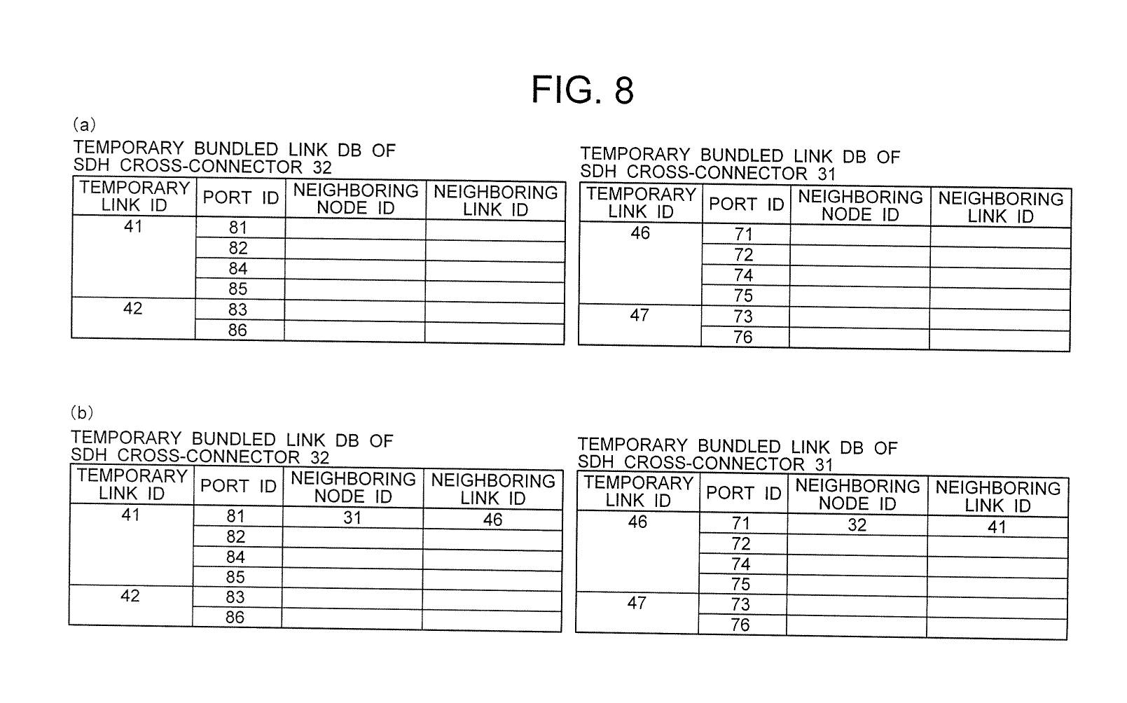

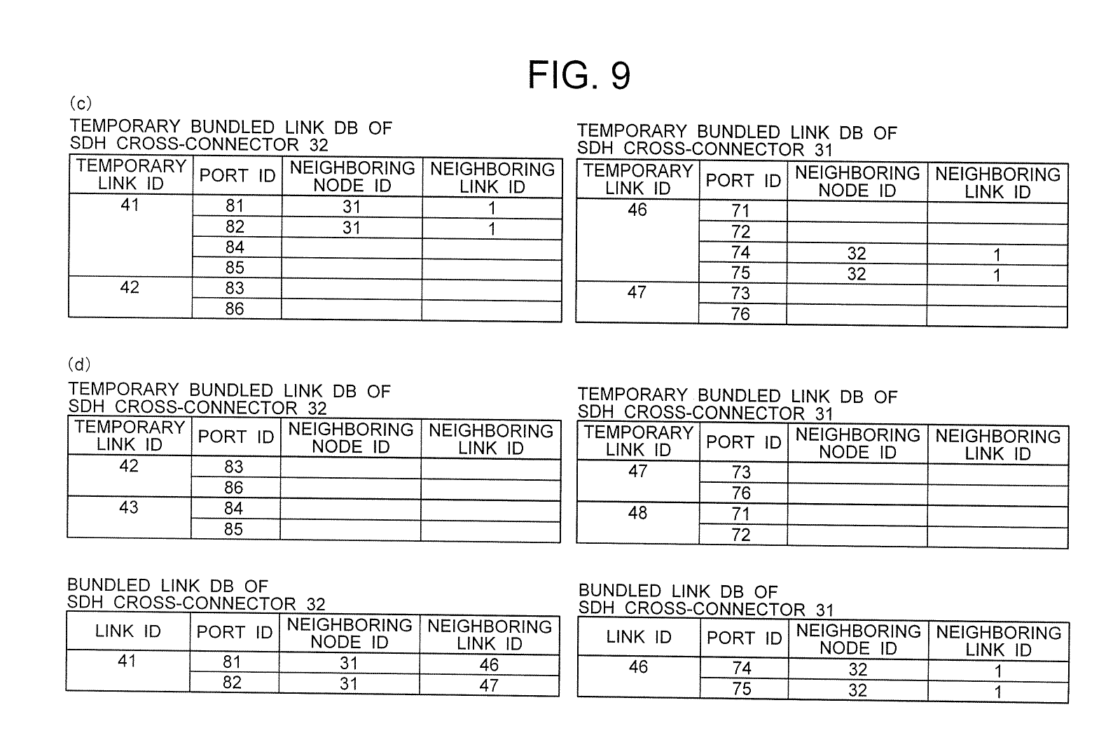

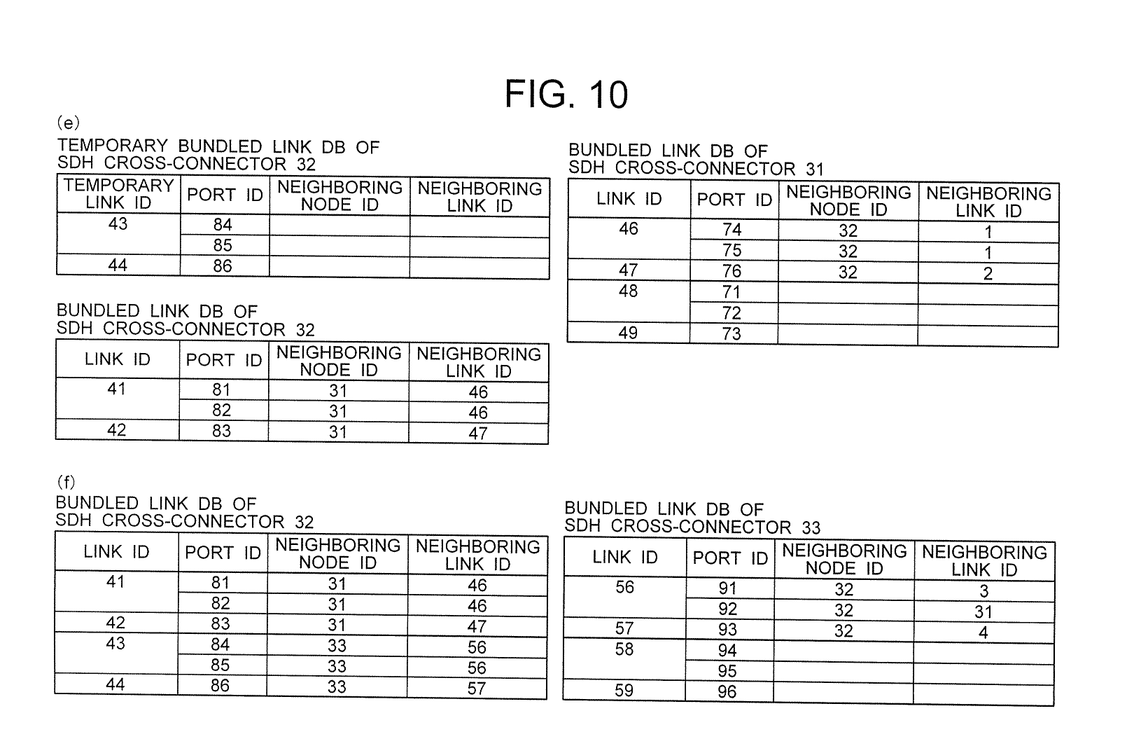

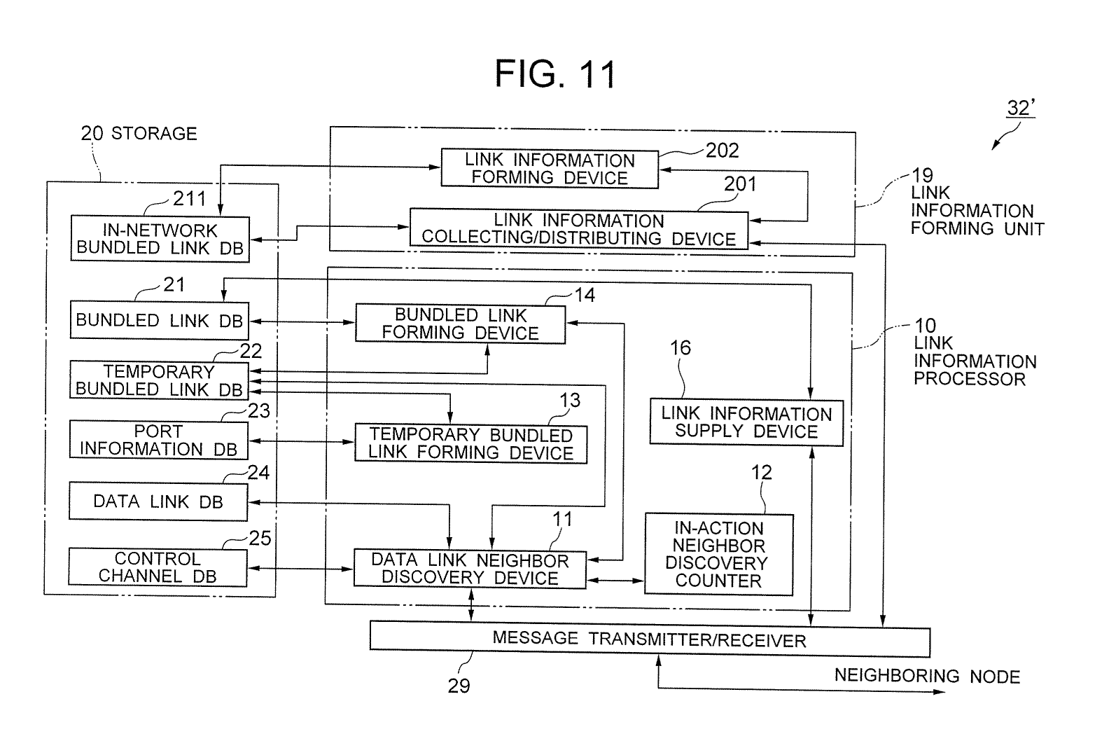

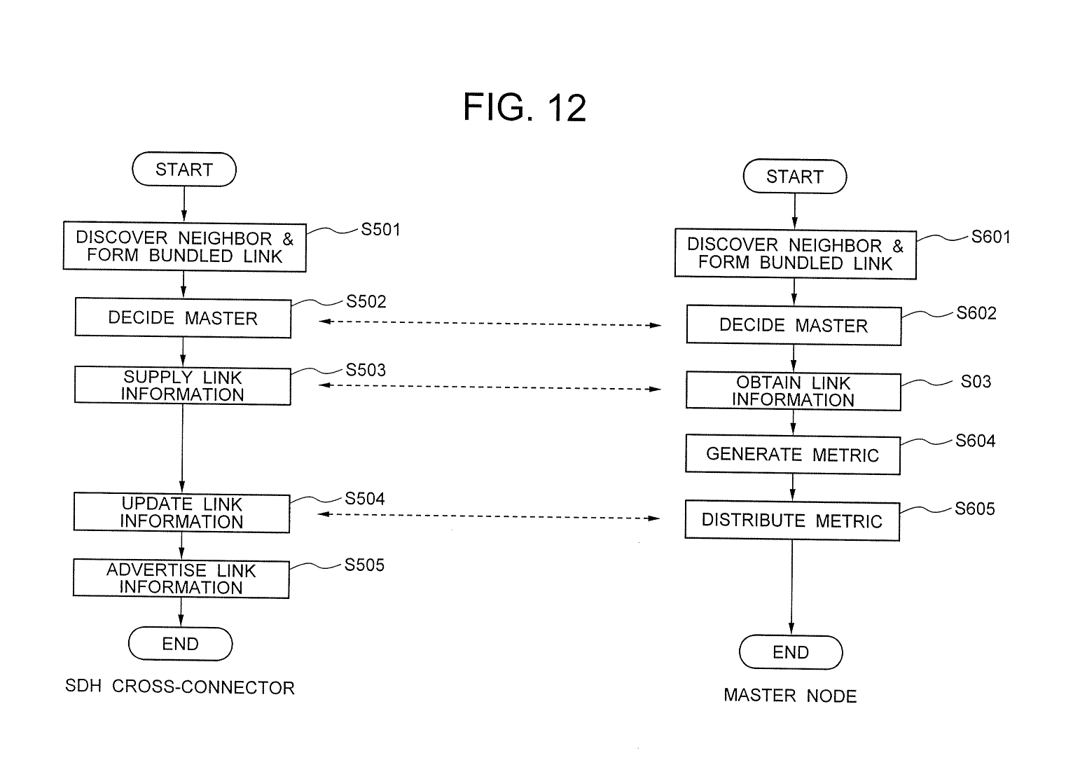

### BRIEF DESCRIPTION OF THE DRAWINGS

[FIG. 1] An overall block diagram for showing a first embodiment of a communication network according to the present invention;

[FIG. 2] A network block diagram for showing SDH cross-connector of FIG. 1;

[FIG. 3] A functional block diagram for showing the SDH cross-connector of FIG. 1;

[FIG. 4] Tables for showing stored contents of each database in FIG. 3, in which FIG. 4[1] is an example of a bundled link database, FIG. 4[2] is an example of a temporary bundled link database, FIG. 4[3] is am example of port information database, FIG. 4[4] is an example of data link database, and FIG. 4[5] is an example of control channel database;

[FIG. 5] A flowchart for showing the entire actions of the SDH cross-connector shown in FIG. 1;

[FIG. 6] A flowchart (1) for showing the procedures for discovering data link neighbor and forming TE link by the SDH cross-connector shown in FIG. 1;

[FIG. 7] A flowchart (2) for showing the procedures for discovering data link neighbor and forming TE link by the SDH cross-connector shown in FIG. 1;

[FIG. 8] Tables (1) for showing the temporary bundled link database and the bundled link database of the SDH cross-connector shown in FIG. 1;

[FIG. 9] Tables (2) for showing the temporary bundled link database and the bundled link database of the SDH cross-connector shown in FIG. 1;

[FIG. 10] Tables (3) for showing the temporary bundled link database and the bundled link database of the SDH cross-connector shown in FIG. 1;

[FIG. 11] A functional block diagram for showing an SDH cross-connector in a second embodiment of the communication network according to present invention; and

[FIG. 12] A flowchart for showing the action of the SDH cross-connector shown in FIG. 11.

### BEST MODE FOR CARRYING OUT THE INVENTION

Next, embodiments of the present invention will be described in detail by referring to the accompanying drawings.

FIG. 1 is an overall block diagram for showing a first embodiment of a communication network according to the present invention. Explanations will be provided hereinafter by referring to this drawing.

The communication network of this embodiment comprises: SDH cross-connectors 31-34; data links (transmission paths) 61-66, etc., which connect and transmit data between the neighboring SDH cross-connectors 31-34; and a control network 5 that is connected to each of the SDH cross-connectors 31-34 to be utilized for transmitting/receiving the control data. Although FIG. 1 only illustrates the connecting relations of the data links with respect to the neighboring SDH cross-connectors, there may actually also be a plurality of other data links as the physical connections than those shown therein. It is noted here that the SDH cross-connectors correspond to the communication apparatuses that constitute the communication network.

FIG. 2 is a network block diagram for showing the SDH cross-connectors 31-33 shown in FIG. 1. Explanations will be provided hereinafter by referring to this drawing.

The SDH cross-connector 31 has a plurality of ports 71-76, the SDH cross-connector 32 has a plurality of ports 81-86, and the SDH cross-connector 33 has a plurality of ports 91-96. Between the SDH cross-connectors 31 and 32, a data link 61 connects between the ports 74 and 81, a data link 62 between the ports 75 and 82, and a data link 63 between the ports 76 and 83, respectively. Further, between the SDH cross-connectors 32 and 33, a data link 64 connects between the port 84 and 91, a data link 65 between the ports 85 and 92, and a data link 66 between the ports 86 and 93, respectively. In addition to the connections through the data links 61-66 for transmitting data, the SDH cross-connectors 31-33 are connected to each other via the control network 5 through which the control protocol is transmitted.

FIG. 3 is a functional block diagram for showing the SDH cross-connector 32 shown in FIG. 2. FIG. 4 shows tables for showing the stored contents in each database shown in FIG. 3. Explanation will be provided hereinafter by referring to these drawings. It is noted that other SDH cross connectors 31 and so on have the same structure as well.

The SDH cross-connector 32 includes: a link information processor 10 that operates through program control; a storage 20 for storing information regarding the links, and a message transmitter/receiver 29 for communicating with other nodes. The storage 20 comprises a bundled link database 21, a temporary bundled link database 22, a port information database 23, a data link database 24, and a control channel database 25. It is noted here that, as described above, a node means a neighboring communication apparatus as a communication target.

As shown in FIG. 4[1], the bundled link database 21 contains IDs of the bundled TE links (link IDs), IDs of the ports (port IDs) contained in the TE links, IDs of the neighboring nodes (neighboring node IDs), and IDs of the TE links of the neighboring nodes (neighboring link IDs). The link ID means the identification information for identifying the data links, which is given to the bundled data links (transmission paths) whose attributes to the port provided to the apparatus main body are the same. The port ID means the identification information for identifying the ports, which is given to each of the ports to which the bundled data links are connected. The neighboring node ID means the identification information for identifying the SDH cross-connectors, which is given to a communication-target SDH cross-connector (communication apparatus) connected mutually through the data link. The neighboring link ID means the identification information for identifying the data links, which is given to a bundle of data links that is obtained by bundling the data links whose attributes to the ports of the communication-target SDH cross-connector are the same.

The temporary bundled link database 22 indicates the candidates for the bundled link before being established as the bundled link and, as shown in FIG. 4[2], contains the IDs of the TE links to be bundled (temporary link IDs), the IDs of the ports (port IDs) contained in the TE links, IDs of the neighboring nodes (neighboring node IDs), and IDs of the TE links of the neighboring nodes (neighboring link IDs). The values of the neighboring node IDs and the neighboring link IDs have not been set yet at the point where the temporary bundled link database 22 is formed, and those values are determined at the stage of discovering the neighbor and forming the bundled link. The temporary link ID corresponds to the identification information for identifying the data links, which is given to the bundled data links (transmission paths) whose attributes to the ports of the apparatus main body are the same. The port ID corresponds to the port ID in the bundled link database 21. The neighboring node ID corresponds to the neighboring node ID in the bundled link database 21. The neighboring link ID corresponds to the neighboring link ID in the bundled link database 21.

As shown in FIG. 4[3], the port information database 23 stores the bandwidth, framing type, and the like of each port as the attributes of the ports. The port information database 23 may be inputted by a network manager or may be formed in advance before executing the bundled link forming device 14 through obtaining it from the SDH cross-connector.

The data link database 24 indicates the information regarding the data links as the physical connections and, as shown in FIG. 4[4], contains the neighboring node IDs and the neighboring port IDs. The port ID corresponds to the port ID in the bundled link database 21. The neighboring node ID corresponds to the neighboring node ID in the bundled link database 21. The neighboring port ID corresponds to the neighboring port ID in the bundled link database 21.

The control channel database 25 presents the information regarding the neighboring nodes that are connected through the data link, and the control channels for achieving communication by utilizing the control network 5. As shown in FIG. 4 [5], the control channel database 25 contains the neighboring node ID, the neighboring control channel ID, and the control channel address for each control channel ID. As shown in FIG. 4[5], a plurality of control channel IDs can be allotted to a single control channel address, or different control channel address can be used for each control channel ID. The information registered into the control channel database 25 may be registered by the network manager in advance. Alternatively, there is also a method which automatically discovers the information as described in BACKGROUND ART.

As shown in FIG. 3, the link information processor 10 comprises a data link neighbor discovery device 11, an in-action neighbor discovering counter (referred to as a counter hereinafter) 12, a temporary bundled link forming device 13, and a bundled link forming device 14.

The data link neighbor discovery device 11 transmits, from the message transmitter/receiver 29, a message for discovering the neighbor by utilizing the control channel that is registered in the control channel database 25, and obtains the neighboring node ID and the neighboring port ID of the port that is provided to the communication-target SDH cross-connector connected to the control channel. The obtained information is registered to the data link database 24 and the temporary bundled link database 22 to be used when the bundled link forming device 14 judges whether or not the neighboring node IDs are the same.

In order to obtain the timing of ending the message monitoring by the data link at the time of discovering the data link neighbor, the counter 12 counts the discovered number of neighbors in action from the number of neighbor discovery start messages and neighbor discovery end messages received from the data link neighbor discovery device 11. The count value of the counter 12 at the start is set as “0”.

The temporary bundled link forming device 13 forms, by utilizing the port information database 23, the bundling relation between the TE links and the data links to be used in the data link neighbor discovery device 11 and the bundled link forming device 14, and registers the data to the temporary bundled link database 22.

The bundled link forming device 14 determines the TE link to which the data link belongs, from the bundling relation between the TE links and the data links registered to the temporary bundled link database 22, and the neighboring nodes obtained from the data link neighbor discovery device 11.

FIG. 5 is a flowchart for showing the entire action of the SDH cross-connector 32 shown in FIG. 2. Explanations will be provided hereinafter by referring to FIG. 2-FIG. 5.

At first, in step S101, the temporary bundled link forming device 13 refers to the port information that is registered to the port information database 23, and registers the ports that have the same registered information to the temporary bundled link database 22 as a single temporary TE link.

As shown in FIG. 4[3], it is assumed that the framing type is SDH for all the ports, the bandwidth of the ports 81, 82, 84, 85 is 2.5 Gbps, the bandwidth of the ports 83, 86 is 10 Gbps. Since the ID information of the neighboring nodes corresponding to each port is unknown at the stage of the step S101, the temporary TE link is formed based on the information kept within the own node. The ports 81, 82, 84, and 85 all have the same bandwidth, 2.5 Gbps, so that those ports are bundled as a single temporary TE link (temporary link ID=41). Further, the ports 83 and 86 both have the bandwidth of 10 Gbps, so that those are bundled as a single temporary TE link (temporary link ID=42). The bandwidth and the framing type are referred to as the port information herein. In addition to those, however, there may also be included a switching capability that indicates whether the unit of switching is the wavelength or the time slot, the minimum bandwidth that can be switched, etc.

Subsequently, in step S102, the SDH cross-connector 32 performs discovery of data link neighbor by the data link neighbor discovery device 11 and forming of the TE link by the bundled link forming device 14. As a result of discovering the data link neighbor among the ports belonging to the same temporary TE link, the bundled link forming device 14 registers the ports having the same ID information of the neighboring SDH cross-connector to the bundled link database 21 as the same TE link.

In FIG. 2, when a plurality of temporary TE links are formed between the same neighboring nodes like the temporary TE links 41, 42 (FIG. 4[2]) formed between the SDH cross-connectors 31 and 32, discovery of the data link neighbor and forming the TE link performed in step S102 are repeated in step S103 until the neighbor discovery for all the temporary TE links is completed.

Further, as shown in FIG. 2, when there are the SDH cross-connectors 31, 33 as the neighboring nodes of the SDH cross-connector 32, i.e. when a plurality of SDH cross-connectors are in the neighboring-node relation to each other, the step S102 for discovering the data link neighbors and forming the TE links and the step S103 for judging whether or not discovery of the neighbors is completed for all the temporary TE links are repeatedly carried out in step S104 for all of the neighboring SDH cross-connectors.

FIG. 6 and FIG. 7 are flowcharts for respectively showing the procedures for finding the data link neighbors and forming the TE links of the SDH cross-connectors 32, 31 shown in FIG. 2. FIG. 8-FIG. 10 are tables for showing the temporary bundled link databases and the bundled link databases of the SDH cross-connectors 32 and 31. By referring mainly to those drawings, explanations will be provided hereinafter by referring to FIG. 2-FIG. 10.

FIG. 6 and FIG. 7 show the details of the TE link forming operations performed between the SDH cross-connectors 32, 31 and the neighbors thereof in the step S102 shown in FIG. 5.

In the temporary bundled link database of FIG. 8(a), there are registered the temporary TE link IDs formed in the step S101 and the ports belonging to the temporary TE links. Since the neighbors of the data links have not been discovered yet, the neighboring node IDs, the link IDs of the TE links of the neighboring nodes are not registered therein.

FIG. 8-FIG. 10 also show the databases of the SDH cross-connector 31 that is the neighbor of the SDH cross-connector 32. The ports 71, 72, 74, and 75 have the same bandwidth, 2.5 Gbps, so that they are bundled and registered as the temporary TE link 46. The ports 73 and 76 have the same bandwidth, 10 Gbps, so that they are bundled and registered as a temporary TE link 47.

At first, in step S103 of FIG. 6, the SDH cross-connector 32 transmits a neighbor discovery start message, indicating the start of discovering the neighbor of the data link through the use of the control channel 51. The neighbor discovery start message contains the node ID=32 as the node ID indicating the transmitter-side SDH cross-connector, and the ID of the temporary TE link as a target of the data link neighbor discovery. The temporary TE link as the target of the data link neighbor discovery may be either the temporary TE link 41 or 42, however, explanation will first be provided assuming that the temporary TE link 41 is selected. It is assumed here that the transmission target of the data link neighbor discovery start message is one of the SDH cross-connectors which are the neighbor nodes of the SDH cross-connector 32 registered in the control channel database 25. There are the SDH cross-connectors 31 and 33 which are discovered in the step S101 as the neighboring nodes of the SDH cross-connector 32. It is assumed here that the SDH cross-connector 31 is selected first as the target of the data link neighbor discovery start message.

Upon receiving the data link neighbor discovery start message in step S401 of FIG. 7, the SDH cross-connector 31 adds “1” to the value of the counter 12. When a data link neighbor discovery end message is received, there is subtracted “1” from the value of the counter, and monitoring of the vacant port is continued while the value is not turned to “0”. Thereby, it is possible to prevent the halt of monitoring caused by one of the neighbor discovery end messages, even when the neighbor discovery start message is received from a plurality of neighboring nodes.

Then, in step S403, monitoring of the vacant ports 71-76 is started. Thereafter, a neighbor discovery start response message is retuned through the control channel 51 in step S404. This neighbor discovery start response message indicates that the preparation for data link neighbor discovery has been completed. The neighbor discovery start response message contains the node ID (node ID=31) for showing the node that has received the neighbor discovery start message, and the neighbor discovery identifier. The neighbor discovery identifier is given to each temporary TE link to which the data link neighbor discovery is performed. Thus, the data link neighbor discovery for each temporary TE link can be identified based on the identifiers. Therefore, discovery of the neighbors of a plurality of temporary TE links and forming the bundled links can be executed simultaneously.

Upon receiving the neighbor discovery start response message in the step S302, the SDH cross-connector 32 transmits test messages to the ports within the temporary TE link 41 in order on the data link in step S303. First, a test message is transmitted to the port 81 on the data link 61. The test message is thoroughly examined to obtain the IDs of the nodes and ports connected on both ends of the data link. This test message contains the port ID of the transmitter-side.

The SDH cross-connector 31 as the receiver-side of the test message receives the test message at the port 74 in step S405. The receiver-side can discover the neighbor of the test message receiving port from the transmitter-side node ID of the neighbor discovery start message, the temporary TE link ID, and the port ID within the test message. Thus, the neighboring information in the data link database and the temporary bundled link database is updated in step S406. In FIG. 8(b), the neighbor node ID=32 and neighbor link ID=41 as the neighbor node of the port 71 are registered to the temporary bundled link database of the SDH cross-connector 31. Then, the SDH cross-connector 31 transmits a test succeeded message in step S407, indicating that the test message has been received properly. The test succeeded message contains the ID of the port that has received the test message for informing the neighbor port to the transmitter-side node of the test message. In this case, the port ID that has received the message is ID =74.

The SDH cross-connector 32 waits for the test succeeded message as a response, and judges in step S304 whether there is received the response or a prescribed time has passed and the time runs out. Regarding the temporary TE link 41 of the SDH cross-connector 32, the ports 81 and 82 are for the SDH cross-connector 31 to which the neighbor discovery start message has transmitted, so that those ports receive the test succeeded message as a response. However, the ports 84 and 85 have not transmitted the neighbor discovery start message, so that there is no test succeeded message returned thereto and the time is to be run out.

Upon receiving the test succeeded message as it has in the port 81, the neighboring relations of the ports are updated in the step S305. As shown in FIG. 8(b), for the port 81 that has received the test succeeded message, there are registered the identification information of the neighboring node and the neighboring temporary TE link ID, which can be obtained from the neighbor discovery start response message. Further, the neighboring node ID=31 and the neighboring port ID=74 are registered for the port 81 of the data link database.

In step S306, the SDH cross-connector 32 checks whether there has been completed the transmission of the test message for all the ports within the temporary TE link 41. With this, the bundled link forming device 14 can judge that the ports that have received the test succeeded message have the same neighboring node, so that the bundled link forming device 14 registers it to the bundled link database 21 (FIG. 9(d)). When there already exists a TE link that has the same port attribute and neighboring node registered within the bundled link database 21, the same link ID as that of the existing TE link may be given for registering it as the same link, or a link ID that is different from the existing TE link may be given for registering it as a different TE link.

In the meantime, the port that has not received the test succeeded message and has run out of the time as the ports 84 and 85 is registered as a new temporary TE link (link ID=43) within the temporary bundled link database 22, as shown in FIG. 9(d).

In step S308, the SDH cross-connector 32 transmits the neighbor discovery end message indicating the end of discovering the neighbor of the temporary TE link 41. The neighbor discovery end message contains the neighbor discovery identifier that is allotted to the neighbor discovery start response message for identifying the neighbor discovery, and the ID of the temporary TE link whose neighbor discovery to be ended. In this case, the temporary TE link ID=41 is contained. Upon receiving the neighbor discovery end message in step S409, the SDH cross-connector 31 registers, as a result of the neighbor discovery, the ports whose neighboring nodes are the same to the bundled link database in step S410.

Thereafter, the neighbor discovery end response message is transmitted in step S411. The neighbor discovery end response message indicates that it has agreed to end the neighbor discovery, and contains the neighbor discovery identifier. Upon receiving the neighbor discovery end response message in step S309, the SDH cross-connector 32 ends the procedures for discovering the neighbor of the temporary TE link 41 and forming the bundled link.

After transmitting the neighbor discovery end response message in the step S411, the SDH cross-connector 31 subtracts “1” from the value of the counter 12 in step S412. If the value of the counter 12 is “0” in step S413, monitoring of all the vacant ports within the SDH cross-connector 31 is ended.

In the method without having any counter for storing such in-action neighbor discovered numbers, with which monitoring is ended upon receiving the neighbor discovery end message, monitoring is to be ended only with the neighbor discovery end message from the SDH cross-connector 31, even though neighbor discoveries from the two nodes of the SDH cross-connectors 31 and 33 are still being executed. However, through storing the number of neighbor discoveries in action, monitoring of other TE links that are under execution of neighbor discoveries can be prevented from being halted even though there is received a certain neighbor discovery end message.

Through the above-described procedure, discovery of the data link neighbors within the temporary TE link and forming the TE link can be performed.

The SDH cross-connector 32 also has the temporary TE link 42 as the temporary TE link, so that the procedures for discovering the neighbor and forming the bundled link are executed also for the ports 83, 86 within the temporary TE link 42. The port 83 is connected to the SDH cross-connecter 31, so that it receives a test succeeded message. Thus, as shown in FIG. 10(e), it is registered to the bundled link database 21 of the SDH cross-connector 32. The other port 86 is not connected to the SDH cross-connector 31, so that the time is run out in the step S304 after transmission of the test message. Thus, it is registered to the temporary bundle link database as a new temporary TE link 44.

Through the operations described above, neighbor discovery of the temporary TE link for the SDH cross-connecter 31 is completed. Then, the SDH cross-connector 32 performs neighbor discovery for the SDH cross-connector 33 that is the remainder of the neighboring nodes registered to the control channel database 25.

The ports 84, 85 contained in the temporary TE link 43 and the port 86 contained in the temporary TE link 44 receive the test succeeded message for the test message, respectively, so that they are registered to the bundled link database 21 as the TE links. FIG. 10(f) shows the bundled link database 21 of the SDH cross-connector 32, after executing the neighbor discovery of the SDH cross-connector 33 and forming the bundled link. The TE links 43 and 44 have the SDH cross-connector 33 registered as the respective neighboring node.

As described above, it is possible with the embodiment to temporarily form the relation between the data link and the temporary TE link by the temporary bundled link forming device 13 based on the port information within the own node. Thus, the TE link can be formed while utilizing the same message format as that of the conventional LMP data link neighbor discovery. Thereby, it becomes unnecessary to set the bundling relation between the TE links and the data links by manual operation, which enables reducing the setting errors and shortening the setting time.

FIG. 11 is a functional block diagram for showing the SDH cross-connector of a second embodiment of the communication network according to the present invention. Explanations will be provided hereinafter by referring to the drawing. Explanations for the same components as those of FIG. 1 and FIG. 3 are omitted by applying the same reference numerals thereto.

This embodiment comprises, in addition to the first embodiment shown in FIG. 3, a link information supply device 16, a link information forming unit 19, and an in-network bundled link database 211 in each of the SDH cross-connectors 31′-34′. In this embodiment, the SDH cross-connectors 31′-34′ comprise the link information forming unit 19, wherein one of the SDH cross-connectors serves as a master (master device), and the master node executes automatic setting of the link information. Illustrations of the SDH cross-connectors 31′, 33′, and 34′ will be omitted, since they may simply be in the same structure as that of the SDH cross-connector 32′. In this embodiment, at least one of the SDH cross-connectors within the network may have the structure shown in FIG. 11, and the rest of the SDH cross-connectors may be the same structure as that of the first embodiment.

The link information supply device 16 informs the master node about the information that is registered to the bundled link database 21 through the message transmitter/receiver 29, and registers the link information allotted by the master node to the bundled link database 21.

The storage 20 contains the in-network bundled link database 211. The information shown in FIG. 4[1] is registered to the in-network bundled link database 211 for each of the SDH cross-connectors 31′-34′ within the network.

The link information forming unit 19 contains a link information collecting/distributing device 201 and a link information forming device 202. The link information collecting/distributing device 201 collects the information registered to the bundled link database 21 from the SDH cross-connectors 31′-34′ as the information to be used for forming the link information. The information to be collected can contain not only the bundled links but also the information on the data links and the ports. The link information forming device 202 performs metric calculation and allotment of SRLG for each bundled link based on the information registered to the in-network bundled link database 211.

FIG. 12 is a flowchart for showing the action of the SDH cross-connector show in FIG. 11. The procedure of network automatic setting according to the embodiment will be described hereinafter by referring mainly to FIG. 12.

At first, each of the SDH cross-connectors 31′-34′ forms the respective bundled link databases 21 in steps S501 and S601 according to the procedures described in the first embodiment.

When forming of the link information is completed, in the steps S502 and S602, each of the SDH cross-connectors 31′-34′ transmits a message through the message transmitter/receiver 29, which is for the link information collecting/distributing device 201 to find the SDH cross-connector to be a master node of the SDH cross-connectors 31′-34′ for automatic setting. This message contains the node ID of the own node and the priority to be the master. One of the SDH cross-connectors 31′-34′ with the high master priority serves as the master for the network automatic setting within the network. One of the SDH cross-connectors 31′-34′ designated in advance may serve as the master without using the master priority.

In the followings, there will be described the method for informing the link information to the master node from each of the SDH cross-connectors 31′-34′ in the step S503. Although the case of the SDH cross-connector 32′ will only be described hereinafter, it applies to the other SDH cross-connector 3′, 3′, and 34′ as well.

The SDH cross-connector 32′ informs the master node that the link information has been updated through utilizing Trap of the SNMP (Simple Network Management Protocol). The master node obtains the link information from the SDH cross-connector 32′ in step S603. As the obtaining method, there is a method in which each of the SDH cross-connectors 31′-34′ keeps the link information as MIB, and the master node collects the link information by utilizing GET of SNMP.

After collecting the information, the master node may display the link information obtained from the SDH cross-connector 32′ on a display to check whether the setting meets the demand or not. By having the manager check the collected information, it is possible to discover the unlawfully placed SDH cross-connector and to prevent the network from operating under an unintentional setting.

In step S604, the master node determines the values of metric and SRLG by the link information forming device 202 based on the link information of the entire network, which is collected by the link information collecting/distributing device 201. Collection of the link information performed in the step S603 obtains the neighboring relations among each of the SDH cross-connectors 31′-34′, so that it is necessary for discovery of the data link neighbors and forming of the TE link to be completed before the step S603.

As an example of a metric allotting method, there is a method which supplies a reciprocal of the bandwidth within the link information that is collected from the SDH cross-connectors 31′-34′. With this, the link of the broader bandwidth is to be used with priority. As another example of the metric allotting method, there is a method which sets the metric of the link connected to a certain node to be larger by a specific ratio compared to the surrounding links. With this, the number of the paths going through this node can be reduced.

Meanwhile, as an example of the SRLG allotting method, unique values are allotted as SRLG to each of the links within the network. This method makes it possible to know the range of influence when there is a fault generated. Thus, through setting the active path and the standby path not to contain the same SRLG, it is possible to avoid such path setting that the active path and the standby path are both affected by a fault.

Further, as another example of the SRLG allotting method, there is a method which allots the same SRLG within the same area. This method enables the two paths not to go through the same area. Such processing for allotting unique values within the network cannot automatically be set only with each of the SDH cross-connectors 31′-34′. It is a function that can be achieved by adding a master node for collecting the information of the entire network.

Examples of the link information affected by the operation policy may be service information supported by the domains contained in the SDH cross-connectors 31′-34′, supported protocols, and option information of the protocols. The information regarding the operation policy becomes unnecessary to be set individually for each of the SDH cross-connectors 31′-34′, and it can be set automatically as long as each takes the same value within the range managed by the master node, such as the supported protocols and service information supported by the domain, through setting the information in the master node in advance.

In step S605, the link attributes determined in the master node are distributed to the SDH cross-connectors 31′-34′. As the distribution method, it is possible to achieve by changing, through SET of SNMP, the link information that is managed by each of the SDH cross-connectors 31′-34′ as MIB. By registering the values of the metric and SRLG formed in the step S604 to the bundled link database 211 of the master node, the information on the entire network can be managed in the master node.

In the step S504, the link information of the SDH cross-connectors 31′-34′ is updated by SET of SNMP from the master node. The SDH cross-connectors 31′-34′ have flags for each link information to indicate the end of setting from the master node and, in the step S504, end the flags when setting from the automatic setting server 1 is ended. The link information whose setting is ended is advertised by using a routing protocol such as OSPF in the step S505.

According to the embodiment, one of the SDH cross-connectors 31′-34′ within the network serves as the master, which collects the link information from each of the SDH cross-connectors 31′-34′, and allots the values based on the information on the entire network. Thus, it enables automatic setting of the information that takes unique values within the network, which has not been achieved conventionally, and automatic setting of the value such as metric that is determined considering over the network topology.

### INDUSTRIAL APPLICABILITY

With the present invention described above, it enables automatic setting of the corresponding relation between the TE links and the data links by utilizing the messages defined in the conventional LMP. Furthermore, the values of metric and SRLG can be set automatically by considering the information on the entire network.

1. A communication network that is built by mutually connecting a plurality of communication apparatuses through transmission paths, wherein
the communication apparatuses mounted in the communication network comprise a temporary bundled link forming device, a data link neighbor discovery device, and a bundled link forming device, wherein:
the temporary bundled link forming device has a function of bundling transmission paths that have same attribute of ports provided to main bodies of the apparatuses, and giving identification information to the bundled transmission paths;
the data link neighbor discovery device has a function of obtaining the identification information given to a communication-target communication apparatus, and the identification information given to the bundled transmission paths of the communication-target communication apparatus; and
the bundled link forming device has a function of determining the transmission paths whose identification information match with each other as a bundled link, based on the identification information of the communication-target communication apparatus, the identification information of the bundled transmission paths of the communication-target communication apparatus, and the identification information of the transmission paths formed by the temporary bundled link forming device.

2. The communication network as claimed in claim 1, wherein the communication apparatuses comprise a link information supply device for supplying information of the bundled link formed by the bundled link forming device to outside.

3. The communication network as claimed in claim 2, wherein the plurality of communication apparatuses are divided into a master apparatus for unifying the communication network and a slave apparatus that subordinates to the master apparatus, wherein:
the master apparatus comprises a link information forming device and a link information collecting/distributing device;
the link information forming device has a function of allotting a new link attribute to the bundled link based on the bundled link information supplied from the link information supply device of the slave apparatus; and
the link information collecting/distributing device has a function of collecting the bundled link information from the link information supply device of the slave apparatus to output the information to the link information forming device, and distributing the link attribute allotted by the link information forming device to the slave apparatus.

4. The communication network as claimed in claim 3, wherein the bundled link forming device of the slave apparatus has a function of giving link information on the network to the transmission paths determined as the bundled link, based on the link attribute information allotted by the link information forming device.

5. A communication apparatus for a communication system connected to each other through transmission paths, which comprises a temporary bundled link forming device, a data link neighbor discovery device, and a bundled link forming device, wherein:
the temporary bundled link forming device has a function of bundling transmission paths that have same attribute of ports provided to main bodies of the apparatuses, and giving identification information to the bundled transmission paths;
the data link neighbor discovery device has a function of obtaining the identification information given to a communication-target communication apparatus, and the identification information given to the bundled transmission paths of the communication-target communication apparatus; and
the bundled link forming device has a function of determining the transmission paths whose identification information match with each other as a bundled link, based on the identification information of the communication-target communication apparatus, the identification information of the bundled transmission paths of the communication-target communication apparatus, and the identification information of the transmission paths formed by the temporary bundled link forming device.

6. The communication apparatus as claimed in claim 5, further comprising a counter for counting number of temporary bundled links of the transmission paths bundled by the temporary bundled link forming device, wherein
the data link neighbor discovery device has a function of obtaining identification information for the communication-target communication apparatus by using the number of temporary bundled links counted by the counter as a condition.

7. The communication apparatuses as claimed in claim 5, further comprising a link information supply device for supplying information of the bundled link formed by the bundled link forming device to outside.

8. The communication apparatus as claimed in claim 7, further comprising:
a link information collecting device for collecting the bundled link information that is supplied from the link information supply device; and
a link information forming device for allotting a new link attribute to the bundled link based on the bundled link information collected by the link information collecting device.

9. The communication apparatus as claimed in claim 5, wherein, as the port attributes, there is contained at least one of information regarding maximum bandwidth or minimum bandwidth that can be processed by the port, framing type, or switching capability.

10. A communication control method for controlling a plurality of communication apparatuses that are connected mutually on a communication network through transmission paths, the method comprising the steps of:
for each of the communication apparatuses, a step for bundling transmission paths that have same attribute of ports provided to main bodies of the apparatuses, and giving identification information to the bundled transmission paths;
for each of the communication apparatuses, a step for obtaining the identification information given to a communication-target communication apparatus, and the identification information given to the bundled transmission paths of the communication-target communication apparatus; and
for each of the communication apparatuses, a step for determining the transmission paths whose identification information match with each other as a bundled link, based on the identification information of the communication-target communication apparatus, the identification information of the bundled transmission paths of the communication-target communication apparatus, and the identification information of the transmission paths formed by a temporary link forming device.

11. The communication control method as claimed in claim 10, comprising, for each of the communication apparatuses, a step of supplying information of the bundled link formed by the bundled link forming device to outside.

12. The communication control method as claimed in claim 11, comprising the steps of:
a step for allotting a new link attribute to the bundled link by a master communication apparatus that collectively manages the communication network, based on the bundled link information collected from a slave communication apparatus as a subordinate to the master communication apparatus; and
a step for distributing the allotted link attribute to the slave apparatus.

13. The communication control method as claimed in claim 12, comprising a step of giving, by the slave communication apparatus, link information on the network to the transmission paths that are determined as the bundled link, based on information of the allotted link attribute.

14. A communication control program for controlling a plurality of communication apparatuses that are connected mutually in a communication network through transmission paths, the program enabling a computer to execute:
for each of the communication apparatuses, a function of bundling transmission paths that have same attribute of ports provided to main bodies of the apparatuses, and giving identification information to the bundled transmission paths;
for each of the communication apparatuses, a function of obtaining the identification information given to a communication-target communication apparatus, and the identification information given to the bundled transmission paths of the communication-target communication apparatus; and
for each of the communication apparatuses, a function of determining the transmission paths whose identification information match with each other as a bundled link, based on the identification information of the communication-target communication apparatus, the identification information of the bundled transmission paths of the communication-target communication apparatus, and the identification information of the transmission paths formed by a temporary link forming device.

15. The communication control program as claimed in claim 14 for enabling the computer to execute, for each of the communication apparatuses, a function of supplying information of the bundled link formed by the bundled link forming device to outside.

16. The communication control program as claimed in claim 15 for enabling the computer to execute, for each of the communication apparatuses,
a function of allotting a new link attribute to the bundled link by a master communication apparatus that collectively manages the communication network, based on the bundled link information collected from a slave communication apparatus as a subordinate to the master communication apparatus; and
a function of distributing the allotted link attribute to the slave apparatus.

17. The communication control program as claimed in claim 16 for enabling the computer to execute, for each of the communication apparatuses, a function of giving, by the slave communication apparatus, link information on the network to the transmission paths that are determined as the bundled link, based on information of the allotted link attribute.

18. A communication network that is built by mutually connecting a plurality of communication apparatuses through transmission paths, wherein
the communication apparatuses mounted in the communication network comprise a temporary bundled link forming device, a data link neighbor discovery device, and a bundled link forming device, wherein:
the temporary bundled link forming device has a function of forming a temporary TE link based on port information within own communication apparatus, when ID information of a neighboring communication-target communication apparatus, which corresponds to the port of the own communication apparatus, is unknown;
the data link neighbor discovery device has a function of discovering, through a control channel, a data link of the communication-target communication apparatus as a neighbor of the temporary TE link that is formed by the temporary bundled link forming device; and
the bundled link forming device has a function of bundling TE links whose identification information and link attribute meet with those of a neighboring communication apparatus, based on temporary TE information outputted from the temporary bundled link forming device and information of the neighboring communication-target communication apparatus outputted from the data link neighbor discovery device.

19. A communication control method for controlling a plurality of communication apparatuses that are connected mutually on a communication network through transmission paths, the method executing the steps of:
a first step for forming a temporary TE link based on port information within own communication apparatus, when ID information of a neighboring communication-target communication apparatus, which corresponds to the port of the own communication apparatus, is unknown;
a second step for discovering, through a control channel, a data link of the neighboring communication-target communication apparatus for the temporary TE link that is formed by the temporary bundled link forming device; and
a third step for bundling TE links whose identification information and link attribute meet with those of a neighboring communication apparatus, based on the temporary TE link information obtained in the first step and information of the neighboring communication-target communication apparatus obtained in the second step.

20. A communication control program for controlling a plurality of communication apparatuses that are connected mutually on a communication network through transmission paths, the program enabling computers that constitute each of the communication apparatuses mounted to the communication network to execute:
a function of forming a temporary TE link based on port information within own communication apparatus, when ID information of a neighboring communication-target communication apparatus, which corresponds to the port of the own communication apparatus, is unknown;
a function of discovering, through a control channel, a data link of the neighboring communication-target communication apparatus for the temporary TE link; and
a function of bundling TE links whose identification information and link attribute meet with those of a neighboring communication apparatus, based on the temporary TE link information and information of the neighboring communication-target communication apparatus.
